(19) United States
(12) Patent Application Publication
(10) Pub. No.: US 2014/0117170 A1
(43) Pub. Date: May 1, 2014

(54) CORD AND TUBE ORGANIZER

(71) Applicants: Gary L. Sharpe, Naples, FL (US); Brian Dutro, Columbus, OH (US)

(72) Inventors: Gary L. Sharpe, Naples, FL (US); Brian Dutro, Columbus, OH (US)

(21) Appl. No.: 14/067,235

(22) Filed: Oct. 30, 2013

Related U.S. Application Data
(60) Provisional application No. 61/720,195, filed on Oct. 30, 2012.

(51) Int. Cl. F16L 3/08

(52) U.S. Cl. CPC F16L 3/08
USPC 248/65

(57) ABSTRACT

A removable cord and tube organizer having a rigid body and an elastic member is described herein. The rigid body has attachment points and channels for attachment of the elastic member when the elastic member is wrapped around an IV pole or other body to affix the organizer thereto.

### CROSS-REFERENCE TO RELATED APPLICATIONS

This application claims priority to U.S. Provisional Application No. 61/720,195, filed Oct. 30, 2012, and incorporates the application by reference as if fully rewritten herein.

### TECHNICAL FIELD

The disclosed embodiments relate generally to a device for organizing a cord in an efficient time saving manner.

### BACKGROUND OF THE ART

Medical advances are occurring at a rapid pace, not only in medical procedures, but also the field of medical devices. However, the increasing number of medical devices is decreasing the amount of patient space and treatment area around a patient. In addition, the increasing number of medical devices generally require a power cable and some form of cord running to the patient for monitoring purposes. With the addition of the IV tubing that may be required it is easy to envision a tangled nest of cables and tubes making it difficult for the patient to move about the room or for health care providers to render treatment to the patient.

A number of devices in the prior art are available for cord organization. These devices are typically designed to specifically clamp onto specific surfaces in a patient's room. Although these devices are useful, they tend to be bulky and difficult to secure and remove. In addition, typically the devices are limited to the types of surfaces or shapes to which they may be applied to. Devices in the prior art may also require a significant amount of time to properly secure to a surface. In an industry where time may be critical for the health of a patient this may create a potential risk. Accordingly, being able to effectively and timely organize cords or tubes is an ongoing challenge in the industry.

Another concern is the spread of germs and bacteria in a hospital or clinic setting. Hospitals and clinics are becoming increasingly aware that their environments play an important role in the transmission of infections and it is becoming clear that the fixtures, curtains, and devices are sites of contamination. Consequently there is a need for a cord and tube organizer that provides a user with the ability to quickly secure it to a number of different shapes and surfaces. Furthermore, it is important to have a cord and tube organizer that can be easily removed for disinfection thus reducing potential contamination.

### SUMMARY

Accordingly, exemplary embodiments of the present invention have been made to remedy the previously mentioned problems. One objective of the exemplary embodiments is to provide a removable cord and tube organizer that can be easily affixed to and removed from a variety of objects and surfaces. When applied to an object in the patient's room, the exemplary cord and tube organizer eliminates the need for health care providers to touch the cords directly. In addition, the exemplary embodiment of the cord and tube organizer reduces the clutter in the patient's room making it safer for both the health care provider and the patient.

The exemplary organizer also improves cleanliness and prevents cross-contamination. Since the organizer is easily removed from the object it may be cleaned and disinfected. Accordingly, the spread of germs and bacteria may be reduced.

Exemplary embodiments according to the inventive concept provides for a cord and tube organizer device. The exemplary organizer includes a readily attachable and readily removable body that is capable of retaining a section of cord or tube. The exemplary cord organizer has a two piece design, where the first piece is a body and a second piece is an elastic member for securing the device to an object. The body includes at least one large aperture to accommodate a portion of the cord or tube to be retained. Other smaller apertures are also included in the body of the organizer. These smaller apertures are for securing the elastic member to the body. The body also includes at least one channel therein. The channels extend inward from the edge of the body and terminate in a notch. The diameters of the notches are greater than the width of the corresponding channels. The body of the cord organizer should be constructed from a material that is easily disinfected.

The elastic member is also constructed from a material that may be disinfected and a diameter larger than the diameter of the notches in the channels and the smaller apertures. The elastic member is secured to the body by threading it through the smaller apertures. This is done by applying a force to the elastic member decreasing its diameter making it possible to pass a portion of the elastic member through the small apertures. Once a desired amount of the elastic member is passed through the aperture the force is removed and the elastic member is returned to its original diameter; however, the portion of the elastic member in the aperture remains at a smaller diameter and applies a force on the aperture holding the elastic member in place. To removably secure the body to an object, the elastic member is wrapped around an object and then forced through the channels and into the corresponding notches therein. The decreased diameter of the notches holds the elastic member in place and in turn secures the body to the object. To remove, simply reverse the process and pull the elastic member out of the channels.

### BRIEF DESCRIPTION OF THE DRAWINGS

These advantages and other characteristics of the disclosed embodiment will be better understood when attention is directed to the accompanying drawings, wherein identical elements are identified with identical reference numerals and wherein:

FIG. 1 is a front view of an embodiment of the cord and tube organizer in a disassembled configuration;

FIG. 2 is a front perspective view of the embodiment of the cord and tube organizer shown in FIG. 1 in an assembled configuration; and

FIG. 3 is a front perspective view of an embodiment of the cord and tube organizer secured to a cylindrical object.

### DETAILED DESCRIPTION OF AN EXEMPLARY EMBODIMENT

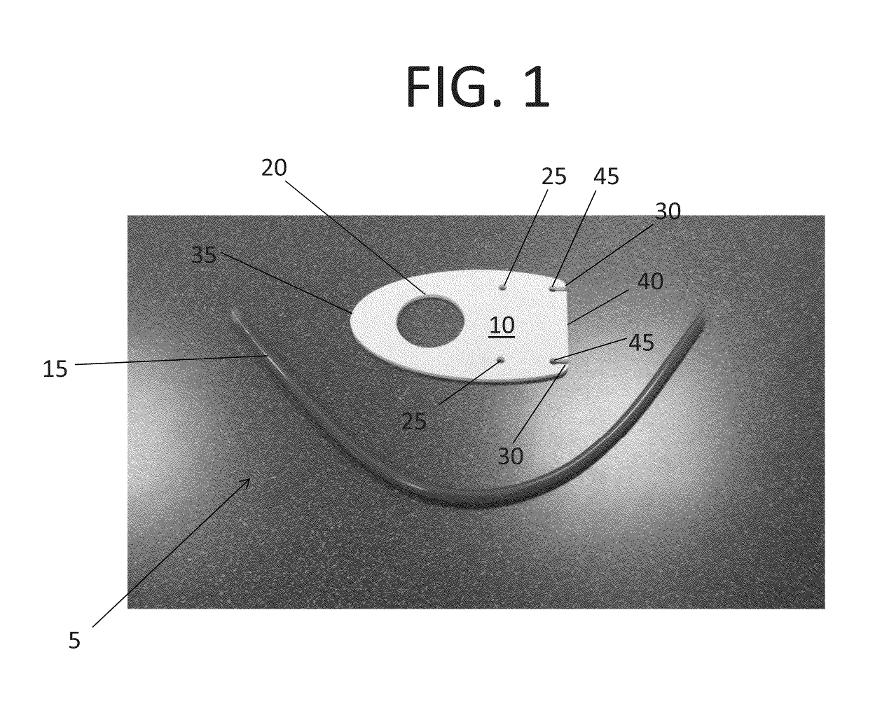

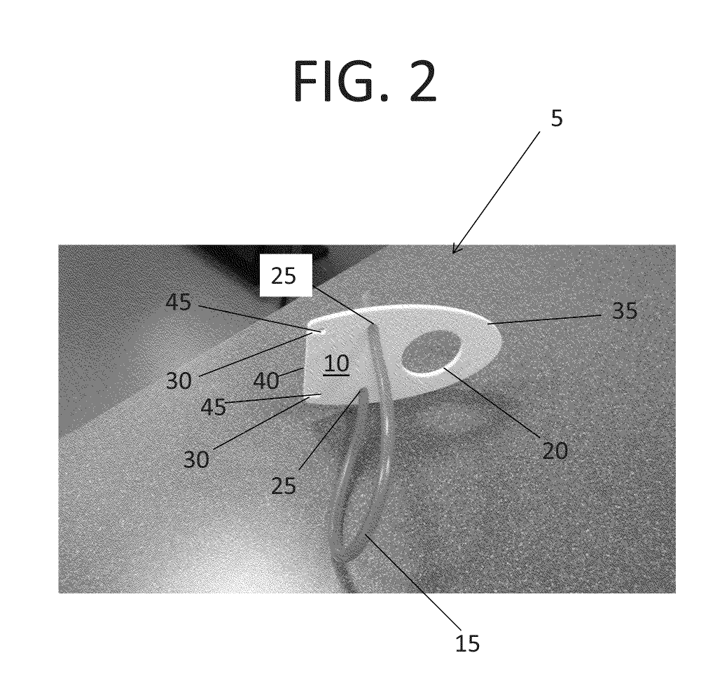

Directing attention to the drawings and particularly to FIGS. 1 and 2, a front perspective view is provided for an embodiment of a cord and tube organizer 5 having a body 10 and an elastic member 15 for attachment thereto. As illustrated, the organizer 5 is constructed from a single piece having multiple features. Specifically, the body of the organizer 10 has a first aperture 20 for securing a cord or IV tube, at least one smaller aperture 25 for securing the elastic member 15 to the body 10, and at least one channel 30 for retaining the elastic member 15. In the unassembled condition of FIG. 1, the cord organizer 5 is ready to be removably affixed to an object such as a bed frame, IV pole, or other feature in a patient's room. It is understood to one of skill in the art that the body 10 may be manufactured from a variety of different materials that are capable of being disinfected and/or sterilized. One exemplary embodiment provides that the body 10 is made from polystyrene. Likewise, the elastic member 15 is also constructed from a material that is easily disinfected.

The body 10 of the cord organizer 5 has a thickness defined by two opposing surfaces. As illustrated in FIG. 1, the body 5 defines an aperture 20 therein. The dimension and shape of the aperture 20 may vary to accommodate a variety of cord sizes. Accordingly, although illustrated as circular the aperture 20 may be triangular, rectangular, or a variety of other shapes. In order to store a cord or tube, the cord or tube may be wrapped tightly and a portion shoved through the aperture 20. The wrapping of the cord or tube is then allowed to loosen and the pressure on the walls of the aperture 20 retains the cord therein. The aperture 20 may retain more than one cord or tube.

At least one smaller aperture 25 is defined by the body 10. In FIG. 1, two apertures 25 are shown. The apertures 25 have a generally circular shape and have a circumference that is less than the circumference of the elastic member 15. To secure the elastic member 15 to the body 10, the elastic member 15 is threaded through the apertures 25, as shown in FIG. 2. Due to the elastic member 15 having a larger dimension than the apertures 25, a pulling force along the longitudinal axis of the elastic member 15 may be necessary to decrease the circumference of the elastic member 15 enough to pass through the apertures 25. After a desired amount of the elastic member 15 has been passed through the apertures 25, the force along the longitudinal axis of the elastic member 15 is released and the elastic member 15 returns to its original dimensions. However, the portion of the elastic member 15 residing in the apertures 25 remains constrained and applies a force to the walls of the aperture 25 sufficient to secure the elastic member 15 to the body 10.

As seen in FIGS. 1 and 2, the body 10 of the exemplary organizer 5 is an elliptical segment similar to a parabola having a curved edge 35 and a straight edge 40. Although shown having a truncated ellipsoid shape, one of skill in the art should realize that the body 10 may have a variety of shapes including oval, circular, and numerous polygonal shapes. Accordingly, there need not be a curved edge or a straight edge.

The body 10 of the organizer 5 additionally includes at least one channel 30 therein. Directing attention to FIGS. 1 and 2, the exemplary body 10 shown therein includes two channels 30. The channels 30 extend inward from the straight edge 40 of the body 10 and terminate at a notch 45. Although it should be understood that the channels 30 ay extend inward from any edge of the body 10. Each channel 30 has a width having a dimension less than the diameter of the elastic member 15. The notches 45 in communication with each channel 30 are circular and have a diameter less than that of the elastic member 15 but greater than the width dimension of the channels 30. This configuration of the channels 30 and the notches 45 allows the elastic member 15 to be forced through the channels 30 into the notches 45 in order to retain the elastic member 15 therein. The diameter difference between the elastic member 15 and the notches 45 should be such that the elastic member 15 can be easily removed, but prevented from movement as a result of the forces applied during normal use. In one exemplary embodiment, the elastic member 15 may have a diameter of about one-quarter of an inch, the notches 45 may have a diameter of three-sixteenths of an inch, and the channels 30 may have a width of about one-eighth of an inch.

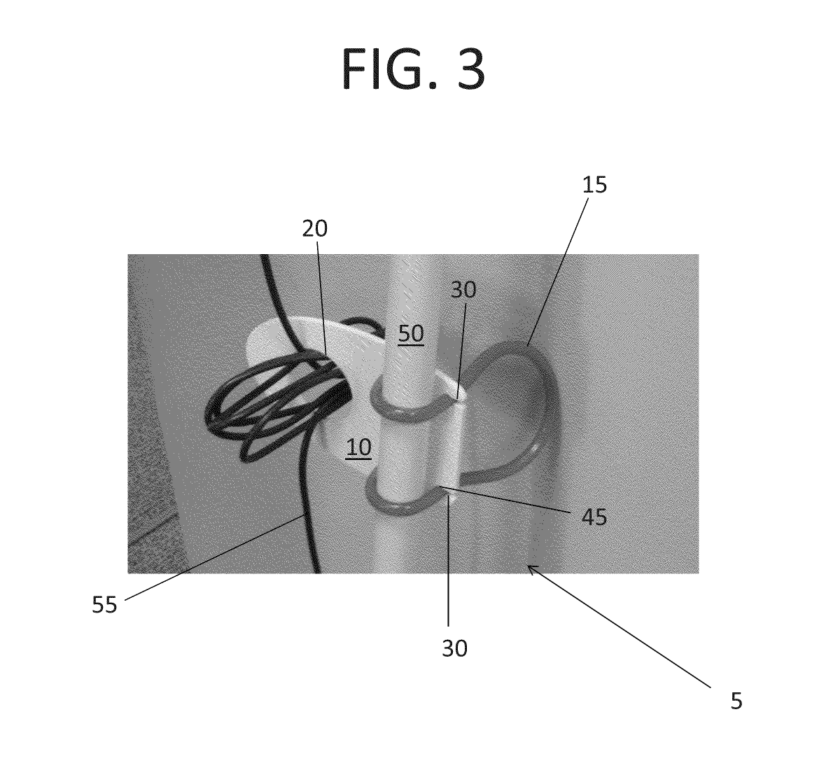

Turning now to FIG. 3, an exemplary organizer 5 is shown attached to cylindrical pole 50 such as an IV pole having a cord 55 held therein. To attach the organizer 5 to an object, such as an IV pole, the elastic member is threaded through the apertures 25, as shown in FIG. 2. The elastic member 15 is then wrapped around the object to which attachment is desired. The wrapping force should be sufficient to stretch the elastic member 15 and secure the organizer 5 to the object. Although attachment is shown to a pole 50 having a cylindrical body, it should be understood that the exemplary organizers 5 may be attached to a variety of objects as long as the elastic member 15 may be wrapped around it and secured in the channels 30 of the organizer 5. Such objects could have a rectangular cross-section, a triangular cross-section, a circular or oval cross-section, or other varieties of cross-sections. Accordingly, the length of the elastic member 15 may be increased in order to be used in conjunction with objects having large dimensions.

After the elastic member 15 is wrapped around the object it is then forced into the channels 30 and rests in the notches 45. As described above, the elastic member 15 is retained within the notches 45 and the channels 30 securing the organizer to the pole 50. Next a cord or tube 55 is wound up and forced through the aperture 20. Once the cord or tube 55 is forced through the aperture it expands and is retained within the aperture 20. To remove the organizer 5 simply remove the elastic member 15 from the notches 45 and channels 30.

FIGS. 1-3 show a single embodiment of an exemplary embodiment of the organizer 5. It should be understood by those skilled in the art that several changes may be made to the organizer 5 while retaining its inventive features. Specifically, the shape of the body 10 can be changed to include a variety of shapes without altering the inventive features. In addition, the number of apertures 25 can be adjusted. Although at least one aperture 25 should be included to retain the elastic member 15, multiple apertures 25 can be included on the body 10. In addition, although FIGS. 1-3 show the apertures 25 in a spaced apart configuration, they may be located close together or in a number of other locations. Likewise, although two channels 30 and corresponding notches 45 are provided, there may be any desired number. It should also be noted that it is typical to have the same number of apertures 25 and channels 30, although some embodiments of the organizer 5 may have different numbers of channels 30 and apertures 25 to provide a variety attachment configurations. Furthermore, although a single elastic member 15 is illustrated, one should understand that a number of elastic members 15 may be utilized depending on the number of channels 30 and apertures 25.

While the embodiments disclosed described the best modes known to the inventor at the time of filing, the scope of the invention is not to be limited to only the embodiments disclosed herein.

What is claimed is:

1. A removable apparatus for the organization of cords and tubes, comprising:
a rigid body portion;
an elastic member;
an aperture in said body portion;
at least one retention aperture, said at least one retention aperture adapted to receive and retain said elastic member;
at least one channel extending inward from an edge of said body portion; and
a notch positioned at the end of said at least one channel, said notch adapted to receive said elastic member.

2. The apparatus of claim 1, wherein said aperture is positioned opposite said at least one channel on said body.

3. The apparatus of claim 1, wherein said at least one retention aperture is positioned between said aperture and said at least one channel on said body.

4. The apparatus of claim 1, wherein said at least one retention aperture has an internal dimension less than the outside radius of said elastic member.

5. The apparatus of claim 1, wherein said notch has an internal radius greater than the width of the said at least one channel.

6. The apparatus of claim 1, wherein said elastic member has an exterior radius greater than the width of said at least one channel.

7. The apparatus of claim 1, wherein said body is a truncated ellipsoid.

8. A removable apparatus for the organization of cords and tubes, comprising:
a rigid body having, a curved edge and a flat edge;
an aperture adapted for retaining a cord or a tube, said aperture positioned toward said curved edge;
a pair of channels extending inwardly into said body from said flat edge;
a pair of retention apertures in a spaced apart configuration, said pair of retention apertures located between said aperture and said pair of channels on said body; and
an elastic member.

9. The apparatus of claim 8, wherein said body is polystyrene.

10. The apparatus of claim 8, wherein said pair of retention apertures are adapted to receive said elastic member.

11. The apparatus of claim 8, wherein said pair of retention apertures retain said elastic member.

12. The apparatus of claim 8, further comprising notches positioned in each of said pair of channels.

13. The apparatus of claim 12, wherein said notches retain said elastic member therein.

14. The apparatus of claim 8, wherein said elastic member has an external radius greater than an internal radius of said pair of retention apertures.

15. The apparatus of claim 8, wherein said elastic member has an external radius greater than a width of pair of channels.

16. The apparatus of claim 12, wherein said notches have an internal radius greater than a width of said pair of channels.

17. A method of organizing cords and tubes, comprising:
providing an organizer having a rigid body and an elastic member;
attaching the elastic member to said rigid body;
placing said rigid body proximate to a member for attachment;
wrapping said elastic member around the member proximate to said rigid body;
attaching said elastic member to said rigid body by insertion of said elastic member into channels in said rigid body such that the organizer is retained on said member; and
placing a cord or a tube to be held in an aperture in said rigid body.

18. The method of claim 17, wherein said elastic member is attached to said rigid body by threading said elastic member through said rigid body.

19. The method of claim 17, wherein said channels in said rigid body extend inward from an edge of said rigid body.

20. The method of claim 17, wherein said elastic member has an outside radius greater than the width of said channels.
